(19) United States
(12) Patent Application Publication
(10) Pub. No.: US 2023/0315868 A1
(43) Pub. Date: Oct. 5, 2023

(54) SYSTEM AND METHOD FOR DISTRIBUTED LAPLACE NOISE GENERATION FOR DIFFERENTIAL PRIVACY

(71) Applicant: Robert Bosch GmbH, Stuttgart (DE)

(72) Inventors: Saraswathy RAMANATHAPURAM VANCHEESWARAN, Weehawken, NJ (US); Jorge GUAJARDO MERCHAN, Pittsburgh, PA (US)

(21) Appl. No.: 17/711,141

(22) Filed: Apr. 1, 2022

(51) Int. Cl. G06F 21/60; G06F 17/14; G06F 7/58; G06F 7/52; G06F 7/556

(52) U.S. Cl. CPC G06F 21/602; G06F 17/14; G06F 7/586; G06F 7/52; G06F 7/556

(57) ABSTRACT

A computer-implemented method includes generating shared random bits at the two or more nodes in a multi-party computation system, obtaining one or more Gaussian samples at the two or more modes utilizing the shared random bits, at each of the two or more nodes, generate and output one or more Laplacian samples using the one or more Gaussian samples.

### TECHNICAL FIELD

The present disclosure relates to multi-party computing.

### BACKGROUND

Secure multi-party computation (MPC) is a field in cryptography which provides a method for many parties to jointly compute a function on a private input. In MPC, the parties obtain some “shares” of the input on which they want to compute the function. MPC may provide a way to keep the input private from the participants of MPC. Moreover, many companies use MPC to jointly compute some functions of their interest without disclosing their private inputs.

### SUMMARY

According to a first embodiment, a computer system for participating in a multiparty computation is disclosed. The computer system includes a processor configured to execute programmed instructions, and a memory for storing the programmed instructions. The programmed instructions include instructions which, when executed by the processor, enable the computer system to implement a secure multiparty computation protocol for a multiparty computation, the multiparty computation defining a function to be computed. The secure multiparty computation protocol includes generating shared random bits by applying random bit generation in a first setting for two or nodes in the multiparty computation, obtaining one or more Gaussian samples at the two or more modes utilizing the shared random bits; and at each of the two or more nodes, generating and outputing one or more Laplacian samples utilizing the one or more Gaussian samples and a standard Laplace distribution.

According to a second embodiment, a computer-implemented method includes generating shared random bits at the two or more nodes in a multi-party computation system, obtaining one or more Gaussian samples at the two or more modes utilizing the shared random bits, at each of the two or more nodes, generate and output one or more Laplacian samples using the one or more Gaussian samples.

According to a third embodiment, a system includes a plurality of processors in communication with one another and programmed to generate shared random bits at the two or more nodes in a multi-party computation system, obtain one or more Gaussian samples at the two or more modes utilizing the shared random bits, and generate and output one or more Laplacian samples using the one or more Gaussian samples.

### BRIEF DESCRIPTION OF THE DRAWINGS

FIG. 1 discloses an embodiment of a distributed computer system.

FIG. 2 depicts a system that includes a plurality of compute nodes and that are communicatively connected to each other via a data network.

FIG. 3A is an illustrative flow chart 300 for distributive sampling to form a Gaussian sample.

FIG. 3B is an illustrative flowchart 350 for distributive sampling to form a Laplace distribution.

FIG. 4A illustrates a graph of samples generated for the Laplace samples in a distributed setting.

FIG. 4B illustrates a graph of samples generated from the Gaussian samples in a distributed setting.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Differential privacy may allow a computer to add noise to data so that the MPC can compute the function without disclosing the exact value of the function, but the value plus the noise. This may keep the privacy of the data and functionality. Multiparty Computation (MPC) may be used to compute privately on data from multiple parties. Such a computation model may be able to provide a secret share for a given input data among the different parties in the computation. The computation is then performed on the secret shares and the output is reconstructed at the end by the parties. Though such a computation allows for computing on data without each party being involved in the computation to reveal their data, there are possible leaks of data from the output itself. To prevent such leakage, a system may apply differential privacy to the result before publishing it. The idea of differential privacy is to add sufficient noise to the output to avoid reverse engineering the data. The commonly used noise distributions for differential privacy include the Gaussian and Laplacian distributions. The disclosure below describes a sampling technique that can be used to sample from the Laplacian distribution using Gaussian samples in a secure distributed computing environment. Such an embodiment may include the advantage that the system or computing device may only need to implement sampling for Gaussian distributions and then reuse them to sample a Laplace distributions.

In one embodiment, protocols for distributed generation of Gaussian and Exponential noise may be presented. The Gaussian noise may be generated as an approximation using Binomial distribution (since coin flipping in secret shared setting has been well studied). This may be based on the fact that for large n, (X−μ)/σ follows a standard normal distribution when X follows a binomial distribution with parameters n,p and μ=np, σ=np(1−p). The protocol is described in algorithm below.

The input may include n —number of players and m—desired number of coins. Assume m=n. The output may include a secret shared sample [x]ⱼ for every party j such that x is a sample from Gaussian distribution N(0,1). In a first step, each player i shares a random bit by sharing out a value bᵢ∈{0,1}_{GF(q)} (denoting conversion of shares from GF(2) to shares of values in a large field GF(q)), using a non-malleable verifiable secret sharing scheme, where q is sufficiently large, and engages in a simple protocol to prove that the shared value is indeed in the specified set. Let [bᵢ]ⱼ denote the Player j's share of bᵢ. In a second step, the system may transform bits bᵢ into sᵢ=bᵢ⊕cᵢ where c₁, . . . , cₙ are unbiased shared random bits from a public source. In a third step, the system may replace each share [sᵢ]ⱼ by 2[sᵢ]ⱼ−1 (mapping shares of 0 to shares of −1 and shares of 1 to different shares of 1). In a fourth step, each participant sums their shares [x]ⱼ=Σᵢ₌₁ⁿ[sᵢ]ⱼ to get a share of the Binomial noise B(n,½). The distributed sampling from normal distribution N(μ,σ)=N(n/2,n/4) may be utilizing binomial approximation.

The disclosure presents protocols to sample in a distributed setting from Gaussian and Exponential distributions. The public coins c₁, . . . , cₙ may be generated by having the parties generate 2n shared random bits b′₁, . . . , b′₂ₙ and applying a deterministic extractor function on the 2n bits. PrivaDA proposes distributed algorithms for sampling from Laplace and Exponential distribution. The Laplace samples may be generated by generating samples from the Exponential distribution and using the fact that a Laplace variable can be represented as X=Y₁−Y₂, where Y₁,Y₂ are Exponential variables. The exponentiation and logarithm operations required for sampling Y₁,Y₂ are observed to be expensive in the MPC setting.

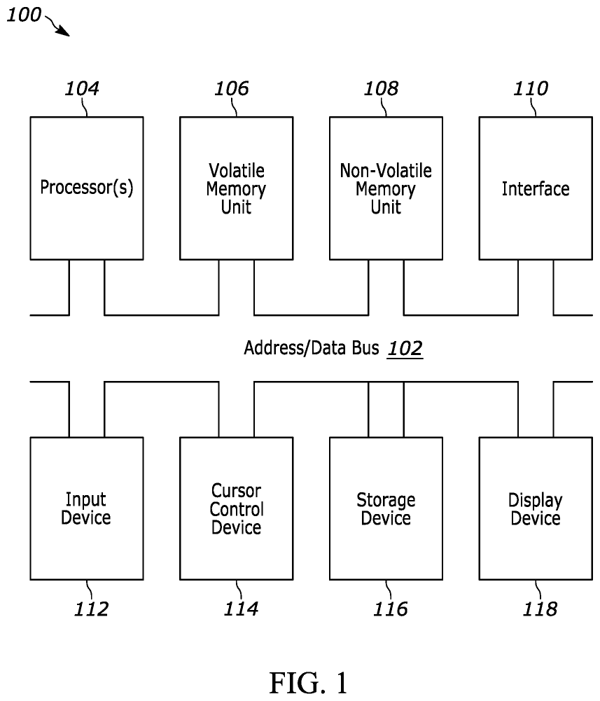

FIG. 1 discloses an embodiment of a distributed computer system. The block diagram depicting an example of at least one computer in the system of the present disclosure is provided in FIG. 1. For example, when implemented in a network with multiple nodes, each node is an independent computer system that communicates with other nodes in the network. Thus, FIG. 1 provides a non-limiting example of at least one of those distributed computer systems 100. Note that the system and method as described herein can be implemented on servers in the cloud as well as desktops or any environment. The distributed computer system 100 may utilize a typical computer or, in other aspects, mobile devices as well as IoT devices (e.g., sensor network), or even a set of control computers on an airplane or other platform that uses the protocol (e.g., a multi-party computation protocol, etc.) for fault tolerance and cybersecurity purposes.

In various embodiments, distributed computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors and/or computers of the distributed computer system 100. When executed, the instructions cause the distributed computer system 100 to perform specific actions and exhibit specific behavior, such as described herein.

The distributed computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor or may be a controller. Alternatively, the processor 104 may be a different type of processor such as a parallel processor, application-specific integrated circuit (ASIC), programmable logic array (PLA), complex programmable logic device (CPLD), or a field programmable gate array (FPGA).

The distributed computer system 100 may be configured to utilize one or more data storage units. The distributed computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The distributed computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the distributed computer system 100 may execute instructions retrieved from an online data storage unit such as in “Cloud” computing. In an aspect, the distributed computer system 100 also may include one or more interfaces, such as an interface 110, coupled with the address/data bus 102. The one or more interfaces are configured to enable the distributed computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the distributed computer system 100 may include an input device 112 coupled with the address/data bus 102, wherein the input device 112 is configured to communicate information and command selections to the processor 100. In accordance with one aspect, the input device 112 is an alphanumeric input device, such as a keyboard, that may include alphanumeric and/or function keys. Alternatively, the input device 112 may be an input device other than an alphanumeric input device. In an aspect, the distributed computer system 100 may include a cursor control device 114 coupled with the address/data bus 102, wherein the cursor control device 114 is configured to communicate user input information and/or command selections to the processor 100. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In one aspect, the distributed computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The distributed computer system 100 presented herein is an example computing environment in accordance with one aspect. However, the non-limiting example of the distributed computer system 100 is not strictly limited to being a distributed computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single or double data processing environment. Thus, in an aspect, one or more operations of various aspects of the present technology are controlled or implemented using computer-executable instructions, such as program modules, being executed by a computer or multiple computers. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

The distributed computing system 100 may include a communication device 130, such as a transceiver, to communicate with various devices and remote servers, such as those located on the cloud 140. The communication device 130 may communicate various data and information to allow for distributed processing of various data and information. Thus, multiple processors may be involved in computing operations. Furthermore, the communication device 130 may also communicate with other devices nearby, such as other computers (including those on the distributed network system), mobile devices, etc.

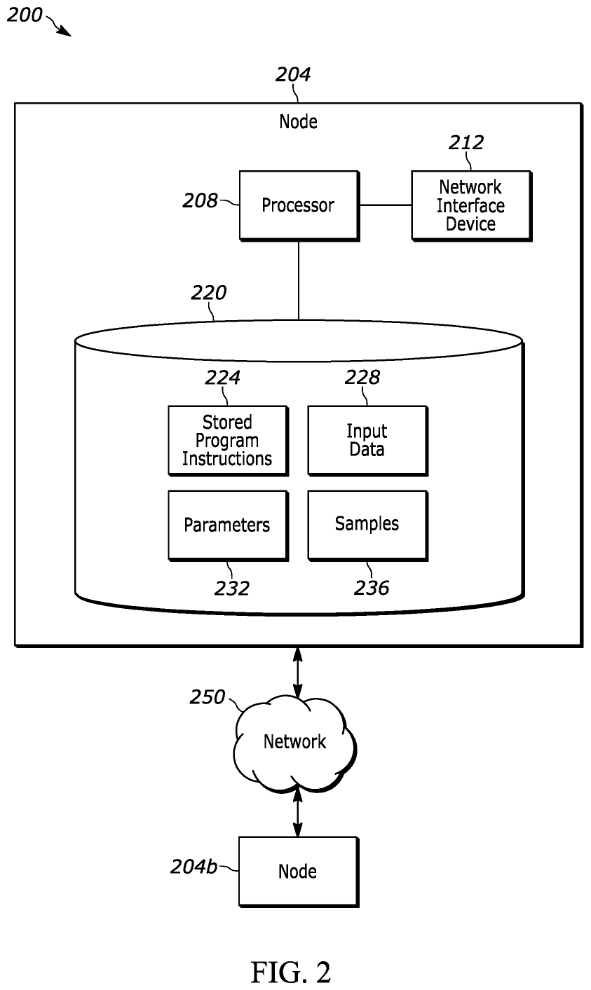

FIG. 2 depicts a system 200 that includes a plurality of compute nodes 204A and 204B that are communicatively connected to each other via a data network 250. In the system 200, each of the nodes 204A and 204B is a party in the MPC processes described herein. Each node is a computing device that acts as a single party in the secure multiparty computations processes that are described herein, and the term “node” is used interchangeably with the term “party” in the embodiments described below. FIG. 2 depicts the node 204A in detail (e.g., secret shared input data), and the node 204B is configured in a similar manner with different sets of stored data to implement a secure multiparty computation using the embodiments described herein. While FIG. 2 depicts a system with two nodes 204A-204B for illustrative purposes, the embodiments described herein can be performed by groups of three or more nodes as well.

Referring to node 204A in more detail, the node includes a processor 208 that is operatively connected to a network interface device 212 and a memory 220. The processor 208 is typically a central processing unit (CPU) with one or more processing cores that execute stored program instructions 224 in the memory 220 to implement the embodiments described herein. However, other embodiments of the processor 208 use different processing elements instead of, or in addition to, a CPU including graphics processing units (GPUs), field programmable gate arrays (FPGAs), application specific integrated circuits (ASICs), digital signal processors (DSPs), and any other digital logic device that is configured to perform the operations described herein. In some embodiments, the processor 208 implements a hardware random number generator (RNG) or uses a software random number generator or pseudo-random number generator (PRNG) to generate the random values. In the description herein, any reference to the generation of a random value or use of a random value refers to the operation of an RNG or PRNG to generate a value in a uniformly random manner selected from a predetermined numeric range (e.g. the finite field Fp).

The network interface device 212 connects the node 204A to a data network 250, such as a local area network (LAN) or wide area network (WAN) to enable communication between the node 204A and the node 204B of FIG. 2, and to additional nodes that perform the secure multiparty computation processes described herein. Non-limiting embodiments of the network interface device 212 include a wired network devices such as an Ethernet adapter or wireless network devices such as a wireless LAN or wireless WAN network adapter. In the system 200, all transmissions of data that are made through the network 250 are assumed to be observed by third party adversaries (not shown in FIG. 2) that can record all data transmitted from the nodes 204A and 204B, although the nodes 204A and 204B may communicate using a transport layer security (TLS) encrypted and authenticated channel or other equivalent communication channel that prevents eavesdroppers from observing or altering communications via the network 250. The embodiments described herein prevent an adversary that can observe communication between the nodes 204A and 204B from determining the value of any private data in addition to preventing the node 204B from identifying the input data 228 of the node 204A and vice versa during computations.

The memory 220 includes one or more volatile memory devices such as random access memory (RAM) and non-volatile memory devices such as magnetic disk or solid state memory devices that store the program instructions 224, input data 228, parameters 232, and samples 236 (e.g., Gaussian samples). The input data 228 may include data that each node receives or has stored, or only one node received or has stored. The input data 228 may be split or shared with other nodes, such as node 205b. The parameters 232 may include a number of shared random bits that are generated at a node or at each node. The computed result may be the final output of the multiparty computation to obtain the Gaussian samples. The node 204B may include a memory with similar data structures except that the node 204B stores a different input data, parameters, and/or samples.

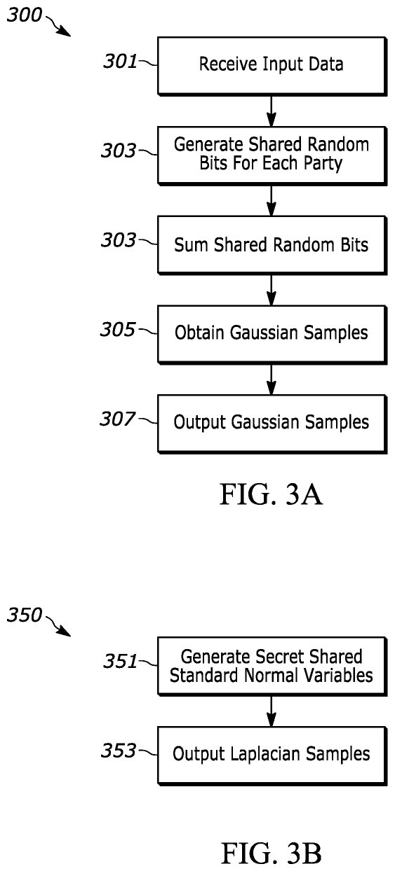

FIG. 3A is an illustrative flow chart 300 for distributive sampling to form a Gaussian sample. The system may provide the algorithm or steps shown in FIG. 3A to sample Gaussian random variables distributive and utilize a theory shown below to drive a Laplace sample distributive. Such a distributed sample generation from Laplacian distribution can be utilized in applying differential privacy to output from MPC computation. A standard classical Laplace random variable X admits the representation X←U₁U₄−U₂U₃ where U₁,U₂,U₃,U₄ are standard normal variables. The Uᵢ's are defined as

$${U}_{1} = \frac{{Z}_{1} - {Z}_{3}}{\sqrt{2}} ,$$

$${U}_{2} = \frac{{Z}_{4} - {Z}_{2}}{\sqrt{2}} ,$$

$${U}_{3} = \frac{{Z}_{4} + {Z}_{2}}{\sqrt{2}} ,$$

$${U}_{4} = \frac{{Z}_{1} + {Z}_{3}}{\sqrt{2}} ,$$

for independent and identically distributed (i.i.d) standard normal variables Z₁,Z₂,Z₃,Z₄.

A new algorithm presented for distributed Laplacian sampling may utilize simple operations such as addition and multiplication. Thus, the system may not need to utilize exponentiation or logarithm functions that are expensive in the MPC setting. The generation of the Laplacian samples may be efficient and the quality of the samples may depend on the quality of the random bits generated.

At step 301, the system may receive input or data. The input or data may be information derived from a database that is connected to one or more nodes of a MPC system. Such input may be deemed to be private, and thus, distributed computing may be utilized to maintain confidentiality of the data. Additionally, the system may determine the parameters and the parameters could be determined based on the input data and the computation being performed by the nodes.

At step 303, the system may generate shared random bits for each party. The shared random bits may be random variated from Bernoulli Distribution with parameter ½. The shared random bits may be generated for every party.

At step 305, the system may obtain the Gaussian samples. The Gaussian samples may be obtained at each node. The Gaussian samples may be obtained by utilizing the shared random bits and their sum.

At step 307, the system may output the Gaussian samples. The Gaussian samples may be derived from a sum of the shared random bits. Each node involved in the MPC may be utilized to output the Gaussian samples.

Gaussian samples. The algorithm may be implemented is as follows:

Input: Additional Parameter: k (number of shared random bits to generate).

Output: Secret shared [X]ⱼ sample X from standard normal distribution N(0,1).
1: Generate shared random bits (random variates from Bernoulli Distribution with parameter ½), [s₁]ⱼ, . . . , [sₖ]ⱼ for every party j.
2: Each Party j computes [Y]ⱼ=Σᵢ₌₁^{k}[sᵢ]ⱼ
3: Each Party j computes [X]ⱼ=([Y]ⱼ−k/2)/(\sqrt{k}/2)

Algorithm 2: Distributed sampling from standard normal distribution N(0,1) using Central limit theorem.

FIG. 3B is an illustrative flow chart 350 for distributive sampling to form a Laplace distribution. FIG. 3B multiple independent Gaussians are combined to compute a Laplacian distribution to derive the noise. To generate the Laplacian, you only need to generate the Gaussians and add them in a particular manner shown in algorithm 3. And you can get the Laplacian at the cost of generating the one or more Gaussians. One noise is based on Gaussian distribution and the other is Laplacian distribution noise.

Such a protocol may allow for distributed Laplace sampling from Gaussian samples. To sample distributive from a Laplace distribution, the system may apply the algorithm disclosed with respect to FIG. 3A to sample Gaussian random variables distributive and propositions to derive a Laplace sample. The algorithm may output secret shares [X]ⱼ of a sample X from standard Laplace distribution. At step 351, the parties may generate Gaussians (e.g., four secret shared standard normal variables) [z₁]ⱼ,[z₂]ⱼ, [z₃]ⱼ,[z₄]ⱼ for every party j using algorithm found with respect to FIG. 3A. At step 353, the system may output the Laplacian samples. Each Party j may compute [X]ⱼ=([z₁]ⱼ²−[z₃]ⱼ²+[z₂]ⱼ²−[z₄]ⱼ²)/2 to obtain Laplacian samples. The Laplacian samples may be applied to input/output (e.g., data) in order to keep privacy associated with computations. The Laplacian samples may be applied at each node to the output of the distributed computation of the nodes.

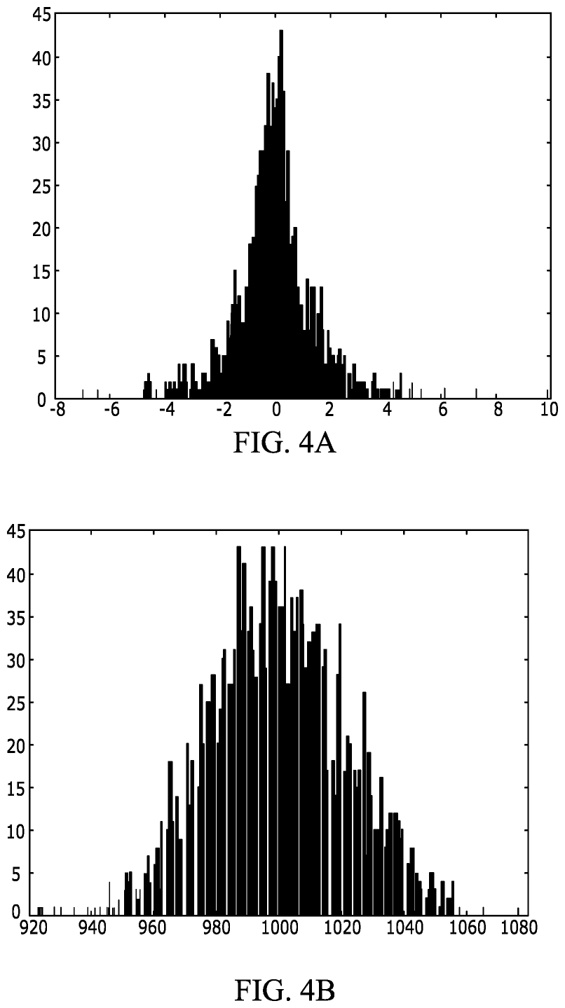

FIG. 4A illustrates a graph of samples generated for the Laplace samples in a distributed setting. FIG. 4B illustrates a graph of samples generated from the Gaussian samples in a distributed setting. The sampling benchmarks are shown below in Table 1.

TABLE 1
Sampling Benchmarks

| Function | Preprocessing data | Time (in seconds) |
|---|---|---|
| Sample_Laplace | 13732 bits, 1705 triples | 0.009 |
| Sample_Gaussian | 3283 bits, 425 triples | 0.003 |

The benchmarks of sampling from the Laplace and Gaussian distributions are as given in Table 1. The samples were generated and tested with preprocessed data generated from running in the offline phase in the MP-SPDZ framework. In such a benchmark, the system generated 1000 samples for Gaussian and 2000 samples for Laplace and used distribution statistical test of fit to ensure that the samples are from the standard Laplace and standard Gaussian as expected at level of significance α=0.05. The tests were run in R with Shapiro Wilk test for Gaussian and Kolmogorov-Smirnov (K-S) test for Laplace. The p-value for the Shapiro Wilk test with the Gaussian samples generated is 0.241 which is greater than the level of significance 0.05. Thus the null hypothesis that the samples are normally distributed cannot be rejected. The p-value for the K-S test with the Laplace samples is 0.742 which is less than the critical value 0.906 and the null hypothesis that the samples are distributed according to the Laplace distribution cannot be rejected. The graphs of the samples generated for the Laplace and Gaussian distribution are shown in FIGS. 4A and 4B.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer system for participating in a multiparty computation, the computer system including:
a processor configured to execute programmed instructions; and
a memory for storing the programmed instructions,
wherein the programmed instructions include instructions which, when executed by the processor, enable the computer system to implement a secure multiparty computation protocol for a multiparty computation, the multiparty computation defining a function to be computed, the secure multiparty computation protocol comprising:
generating shared random bits by applying random bit generation in a first setting for two or more nodes in the multiparty computation;
obtaining one or more Gaussian samples at the two or more modes utilizing the shared random bits; and
at each of the two or more nodes, generate and output one or more Laplacian samples utilizing the one or more Gaussian samples and a standard Laplace distribution.

2. The computer system of claim 1, wherein the sampling includes utilizing a central limit theorem approximation.

3. The computer system of claim 1, wherein random bit generation is performed in the MP-SPDZ setting.

4. The computer system of claim 1, wherein random bit generation is performed in the MP-SPDZ setting utilizing a central limit theorem.

5. The computer system of claim 1, wherein the Laplacian sampling utilizing either addition or multiplication.

6. The computer system of claim 1, wherein the Laplacian sampling does not utilize either exponentiation or logarithmic functions.

7. The computer system of claim 1, wherein the one or more Gaussian samples is exactly four Gaussian samples.

8. The computer system of claim 1, wherein the one or more Laplacian samples are utilized on computation data to generate noise in a differential privacy computation.

9. A computer-implemented method, comprising:
generating, utilizing a processor, shared random bits at the two or more nodes in a multi-party computation system;
obtaining, utilizing the processor, one or more Gaussian samples at the two or more modes utilizing the shared random bits;
at each of the two or more nodes, generate and output, utilizing the processor, one or more Laplacian samples using the one or more Gaussian samples.

10. The computer-implemented method of claim 9, wherein the shared random bits are generated utilizing a Bernoulli Distribution.

11. The computer-implemented method of claim 9, wherein the Laplacian sampling is generated using either addition or multiplication.

12. The computer-implemented method of claim 8, wherein the Laplacian sampling is generated does not utilizing either exponentiation or logarithmic functions.

13. The computer-implemented method of claim 8, wherein generating shared random bits includes utilizing a central limit theorem approximation.

14. The computer system of claim 8, wherein generating shared random bits is performed in the MP-SPDZ setting.

15. The computer system of claim 8, wherein generating shared random bits is performed in the MP-SPDZ setting utilizing a central limit theorem.

16. A system, comprising:
a plurality of processors, the processors in communication with one another and programmed to:
generate shared random bits at the two or more nodes in a multi-party computation system;
obtain one or more Gaussian samples at the two or more modes utilizing the shared random bits; and
generate and output one or more Laplacian samples using the one or more Gaussian samples.

17. The system of claim 15, wherein the Gaussian samples are obtained utilizing a sum of the shared random bits.

18. The system of claim 15, wherein the plurality of processors are programmed to apply the one or more Laplacian samples on output data in the multi-party computation system.

19. The system of claim 15, wherein the shared random bits are generated utilizing a Bernoulli Distribution.

20. The computer system of claim 15, wherein the Laplacian sampling does not utilize either exponentiation or logarithmic functions.
